(19) United States
(12) Patent Application Publication
(10) Pub. No.: US 2024/0257540 A1
(43) Pub. Date: Aug. 1, 2024

(54) ARTIFICIAL INTELLIGENCE SITUATION MONITORING SOFTWARE

(71) Applicant: Agricair, Inc., Olivet, MI (US)

(72) Inventors: Brian Mullen, Holland, MI (US); Kyle O'Brien, Charlotte, MI (US); Hilary Triick, Conklin, MI (US); Miriah Dershem, Ovid, MI (US)

(73) Assignee: Agricair, Inc., Olivet, MI (US)

(21) Appl. No.: 18/419,480

(22) Filed: Jan. 22, 2024

Related U.S. Application Data
(60) Provisional application No. 63/482,360, filed on Jan. 31, 2023.

(51) Int. Cl. G06V 20/64; G06V 20/40

(52) U.S. Cl. CPC G06V 20/64; G06V 20/44

(57) ABSTRACT

A method of using artificial intelligence (AI) to monitor situations, or a non-transitory computer-readable storage medium on which is recorded instructions. The method may include using one or more cameras to monitor one or more objects; processing, with AI, images or moving images from the camera; determining whether a problem is occurring within the images or moving images from the camera; and reporting possible problems to a receiving point. In some situations, the monitored objects are animals. The receiving point may be a dashboard monitored by a human, who can review and determine whether possible problems are actual problems, including animal abuse. In some configurations, Optical Flow is used to capture motion within the images or moving images. In other situations, the monitored objects may be humans, and the possible problems reported from the images or moving images from the camera may be criminal actions.

### CROSS-REFERENCE TO RELATED APPLICATIONS

This application claims the benefit of U.S. Provisional Application No. 63/482,360, filed 31 Jan. 2023 which is hereby incorporated by reference in its entirety.

### INTRODUCTION

This disclosure generally relates to software using artificial intelligence (AI) to monitor and/or manage situations, including farms that have animals.

### SUMMARY

A method of using artificial intelligence (AI) to monitor situations is provided. The method includes using one or more cameras to monitor one or more objects; processing, with AI, images or moving images from the camera; determining whether a problem is occurring within the images or moving images from the camera; and reporting possible problems to a receiving point.

In some situations, the monitored objects are animals. The receiving point may be a dashboard monitored by a human, who can review and determine whether the possible problems are actual problems, including animal abuse. In some configurations, Optical Flow is used to capture motion within the images or moving images.

In other situations, the monitored objects may be humans, and the possible problems reported from the images or moving images from the camera may be criminal actions. Therefore, the human at the dashboard may determine whether the possible criminal actions are actual criminal actions.

A non-transitory computer-readable storage medium on which is recorded instructions is also provided. Execution of the instructions by a processor causes the processor to use one or more cameras to monitor one or more objects; process, with AI, images or moving images from the one or more cameras; determine whether a problem is occurring within the images or moving images from the one or more cameras; and report any possible problems to a receiving point.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIGS. 1A and 1B schematically illustrate portions of a flow chart representing an AI-based farm monitoring software system, focusing on animal wellness or welfare.

FIGS. 2A and 2B schematically illustrate portions of a flow chart representing an AI-based farm monitoring software system, focusing on feed lanes.

FIGS. 3A and 3B schematically illustrate portions of a flow chart representing an AI-based farm monitoring software system, focusing on detecting lameness.

FIGS. 4A and 5B schematically illustrate portions of a flow chart representing an AI-based farm monitoring software system, focusing on body condition scoring (BCS) of one or more animals.

FIGS. 5A and 5B schematically illustrate portions of a flow chart representing an AI-based farm monitoring software system, focusing on parlor management.

FIGS. 6A and 6B schematically illustrate portions of a flow chart representing an AI-based farm monitoring software system, focusing on transition management.

FIG. 7 schematically illustrates a plurality of cattle comparing, at least, open flow motion capture and optical flow motion capture.

FIG. 8 schematically illustrates use of the methods described herein, such that the methods have identified, within video captured by a camera, a human hitting a cow, in addition to a wheelbarrow within a barn.

### DETAILED DESCRIPTION

Referring to the drawings, like reference numbers correspond to like or similar components wherever possible throughout the several figures. All figures may be referred to in any section of the specification, without regard to numerical order.

While the present disclosure may be illustrated with respect to particular industries or applications, those skilled in the art will recognize the broader applicability of the products, methods, and techniques, described herein. For example, similar structures, methods, or combinations thereof, may be used in other industries or for other procedures/processes than those described herein. The order of any method or process steps described herein is not limiting.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way.

When used herein, the term “substantially” refers to relationships that are ideally perfect or complete, but where manufacturing realities prevent absolute perfection. Therefore, substantially denotes typical variance from perfection in the relevant art. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be within 5%.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting.

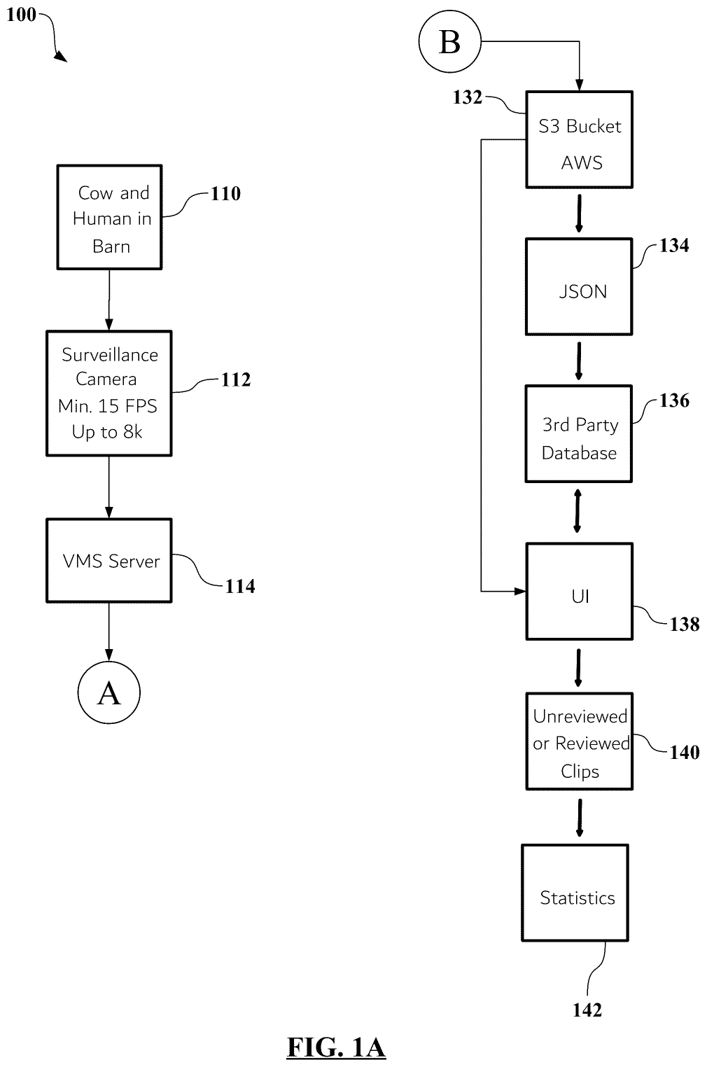

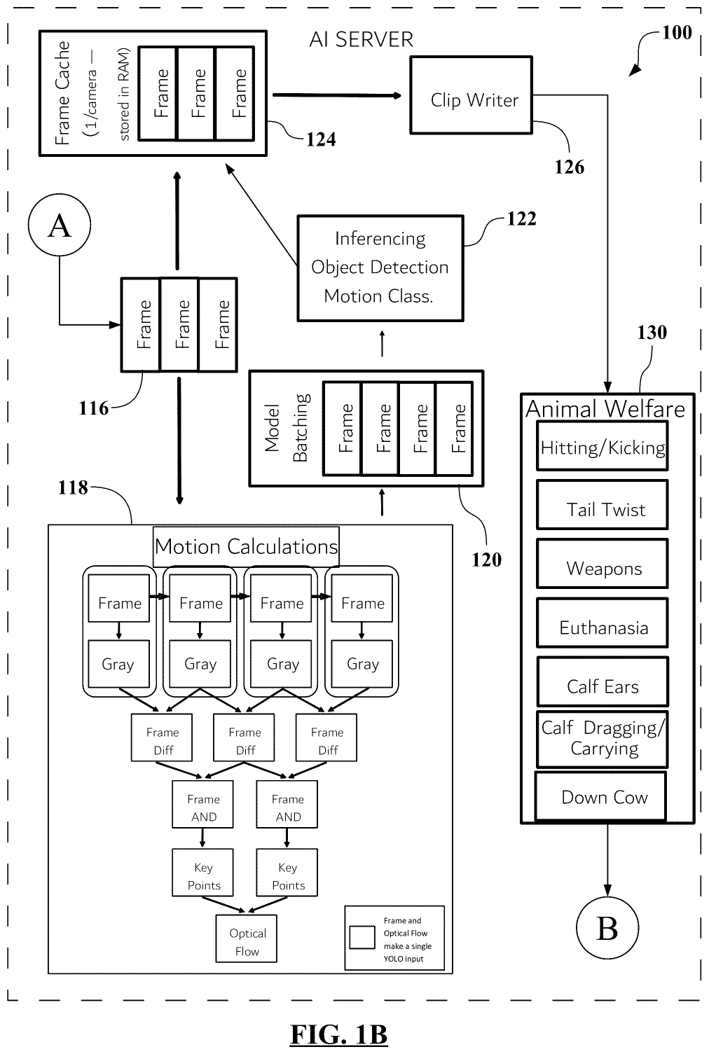

As shown in FIGS. 1-6 there are various schematic views of flow charts illustrating different aspects of an AI-based farm monitoring and management software system. Note that the steps may move back and forth between one another.

FIGS. 1A and 1B schematically illustrate portions of a flow chart or method 100 focusing on animal wellness. Note that the method 100 may move back and forth between FIGS. 1A and 1B.

### Step 110: Start; Cow and Human in Barn.

The method 100 generally starts or begins at a step where the AI method 100 realizes that a cow and a human are in the barn together. Other triggers may also start method 100. Note that all of the methods described herein may be looping iteratively and/or constantly looking for trigger events to begin any of the processes described herein. Note that the methods and systems described herein may recognize other objects, including equipment used on the farm.

Note that although the specific animals referenced in the figures and/or discussion may be bovines (including, without limitation, cattle), the methods and systems may be used for other animals. Additional animals may include, without limitation: sheep, pigs, alpacas, chickens or turkeys, or other types of animals that will be recognized by those having ordinary skill in the art.

Additionally, the methods described herein may be used on humans. For example, and without limitation, the AI methods may be used to identify when humans may be committing a crime, or performing other activities that need to be monitored, via cameras monitored by the AI systems described herein.

A generalized control system, computing system, or controller is operatively in communication with relevant components of, at least, the systems described herein. The controller includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols. One or more of the methods described herein may be executed by the controller, including the non-transitory computer-readable storage medium, or other structures or equipment recognizable to skilled artisans.

Furthermore, the controller may include, or be in communication with, a plurality of sensors, including multiple cameras. The controller is configured to execute or implement all control logic or instructions described herein and may be communicating with any sensors described herein or recognizable by skilled artisans. The controller may be dedicated to the specific aspects of the systems described herein or may be part of a larger control system that manages numerous other functions.

The generalized control system executes artificial intelligence (AI) via any methods or techniques recognizable to those having ordinary skill in the art. Note that the control system may be using one or more servers and/or cloud servers for operation.

### Step 112: Surveillance Camera.

One or more surveillance cameras, or simply cameras, are monitoring conditions withing the barn or other areas, such as outside of the barn. The cameras will likely, but without limitation, have a frame rate of at least 15 frames per second (FPS). In many configurations, the cameras may be 4K, 8K, or higher resolution. Note that one or more of the camera streams may be from a drone.

### Step 114: Video Management Server (VMS).

The clips, frames, or images taken by the cameras are sent to a VMS, which is video management server (VMS), for further processing. After step 114, method 100 proceeds to FIG. 1B via connector A.

### Step 116: Frame Processing.

Step 116 involves processing the frames captured by the cameras and then sending those frames to other steps. Note that the entirety of FIG. 1B occurs within the AI Server. The AI server may be the same as the VMS or may be different servers or clouds.

### Step 118: Motion Calculations.

At step 118, method 100 works to detect or calculate motion from the images captured by the cameras. Importantly, the method 100 uses Optical Flow, as opposed to pose estimation like that performed by OpenPose or OpenFlow, to calculate, capture, and/or measure motion. Motion calculations determine whether there is something that needs to be identified in the frame image or moving images.

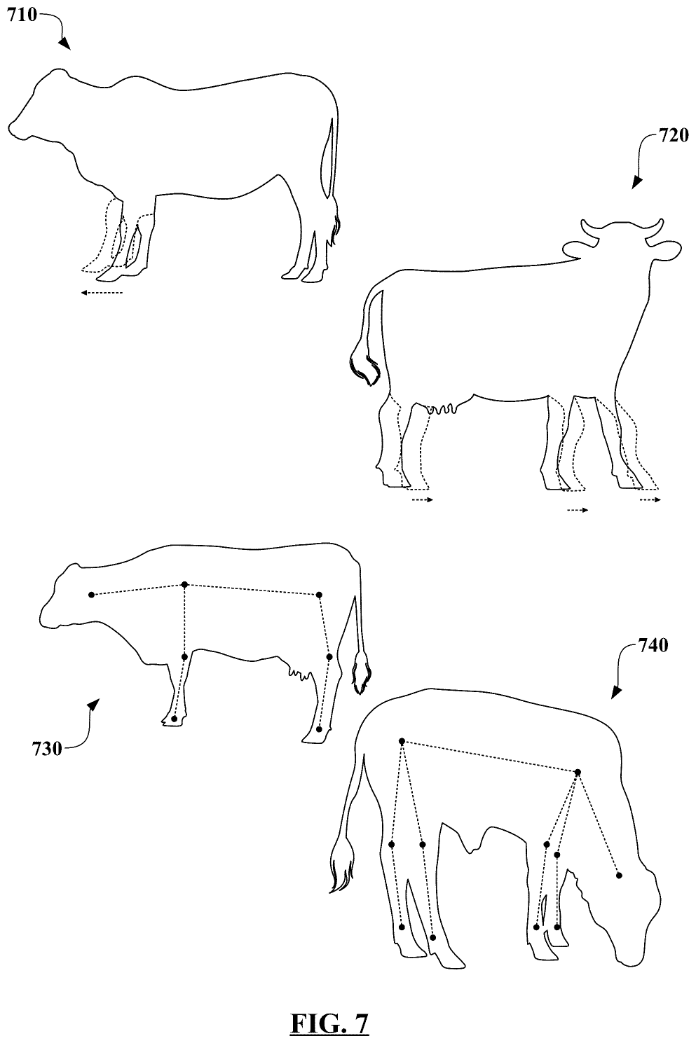

Optical Flow, as illustrated in FIG. 7, uses pixels and changes to pixels from one frame to the next to determine movement or calculate motion. Alternatively, key points within a frame can be determined and those points tracked from frame to frame, such that motion is calculated based on the key points. Contrarily, OpenPose assigns stick figures to calculate movement, as is often used in movie special effects.

FIG. 7 schematically illustrates a plurality of cattle comparing, at least, Optical Flow motion capture and OpenPose motion capture. Two upper cattle 710 and 720 schematically illustrate Optical Flow motion capture, where the movement of the legs of the cattle are captured by comparing movement of the pixels or points (or key points identified by the AI systems) representing the legs. Two lower cattle 730 and 740 schematically illustrate OpenPose motion capture, or similar, where the animals are assigned stick figures, such that movement is tracked via movement of the stick figures.

Note that both the Optical Flow and OpenPose are shown highly schematically in FIG. 7. Skilled artisans will recognize the exact processes used for calculating movement via each process, and others that are not discussed but may be used with the methods described herein. Furthermore, skilled artisans will recognize that OpenPose may require additional processing capacity and/or time relative to using Optical Flow to determine movement within the frames and images captured by the cameras.

Optical Flow may utilize filters and/or coloration to sort movement types. For example, fast movement may be assigned a red coloration with slower movement assigned yellow. Alternatively, gray scales may be used. Optical Flow may use neural networks or neural computing for calculation of movement within the AI server.

Note that, the methods described herein do not need all of the pixels, such that only some of the pixels, or points derived from the pixels, may be used to improved computational efficiency. For example, and without limitation, the methods may find points with high visual contrast, such as edges or corners, which allows the identification of specific points. Thereafter, the methods may see the difference in movement between the frames based on those, points, or key points.

The Optical Flow used by the method 100 may utilize, without limitation, the Lucas-Kanade method, which is a widely used differential method for optical flow estimation. It generally assumes that the flow is essentially constant in a local neighborhood of the pixel under consideration and solves the basic optical flow equations for all the pixels in that neighborhood with the least squares criterion. By combining information from several nearby pixels, the Lucas-Kanade method can often resolve the inherent ambiguity of the optical flow equation(s). It is also less sensitive to image noise than point-wise methods. Note that skilled artisans will recognize other techniques or methods for optical flow estimation of motion calculation.

For motion calculation, the method 100 may also use, without limitation, HSL (for hue, saturation, lightness) and HSV (for hue, saturation, value) are alternative representations of the RGB color model. The HSV representation models how colors appear under light. The difference between HSL and HSV is that a color with maximum lightness in HSL is pure white, but a color with maximum value/brightness in HSV is analogous to shining a white light on a colored object—e.g., shining a bright white light on a red object causes the object to still appear red, just brighter and more intense, while shining a dim light on a red object causes the object to appear darker and less bright.

The hue is represented as an angle within the cylinder of the HSL or HSV. The color differentiations assist method 100 in determining both the direction and magnitude of movement. Additionally, this helps the method 100 determine the motions and/or identify the activity going on in the video.

The different frames are represented as a matrix with 3 channels, red, green, and blue. The angle and magnitude of movement are also incorporated into the matrix. You only look once (YOLO) is an industry name for deep learning the minimizes processing needs.

Optical Flow uses the flow of the pixels or points (or key points) from frame to frame, fast moving pixels change color relative to slower pixels (this may be a mask that is applied). Combine that with another mask that uses directional analysis computations—also changing colors based on the direction of movement—and you can combine the direction and movement to determine velocity. Optical Flow is significantly faster processing than OpenPose or OpenFlow.

The method 100 may also use, without limitation, features from accelerated segment test (FAST) as a corner detection method, which could be used to extract feature points and later used to track and map objects in the computer vision tasks of method 100, supplementing or substituting for the pixels within a frame. One advantage of the FAST corner detector is its computational efficiency, which is faster than many other well-known feature extraction methods, such as difference of Gaussians (DoG). Moreover, when machine learning techniques are applied, superior performance in terms of computation time and resources can be realized. The FAST corner detector is very suitable for real-time video processing applications because of the high-speed performance.

### Step 120: Model Batching.

At step 120, method 100 uses model batching to determine how to send computations from the central processing unit (CPU) to the graphics processing unit (GPU). This is because the GPU is the preferred method for solving matrix algebra over the CPU. Model batching determines and sends an optimal batch size to the GPU and then receives the results back from the GPU to the CPU.

### Step 122: Inferencing, Object Detection, and Motion Classification.

At step 122, method 100 uses inferencing, object detection, and motion classification. Inferencing is where capabilities learned during deep learning are put to work. Inference cannot happen without training.

Object detection, in artificial intelligence, allows computer systems to “see” their environments by detecting objects in visual images or videos. For example, and without limitation, object detection determines the cow's position or action and/or determines that a human is in proximity to the cow. Note that object detection may also be used to detect other objects, including, without limitation, vehicles (ATVs, loaders), equipment (shovels, wheelbarrows), or various types of weapons.

Object detection is looking at a picture and identifying the objects within the frame. Motion classification, in artificial intelligence, allows computer systems to interpret the movement of pixels, points, or represented objects in a sequence of frames to classify actions or behaviors that cannot be determined by a single image or single video frame. Motion classification identifies the actual movements, such as hitting—or other actions discussed relative to the animal welfare block-which cannot be identified by a single frame with object detection.

### Step 124: Frame Cache.

At step 124, method 100 uses a frame cache. Each camera may have its own frame cache, without limitation, and the frame cache may be stored in random access memory (RAM).

### Step 126: Clip Writer.

At step 126, method 100 writes the clips to, or within, the AI server.

### Step 130: Animal Welfare.

At step 130, method 100 determines whether there are any animal welfare incidents occurring with the clips by using AI. The examples of possible animal welfare incidents within the animal welfare box/block are examples only, and do not limit the scope of the invention. Many of these are forms of animal abuse, but other actions may also be monitored.

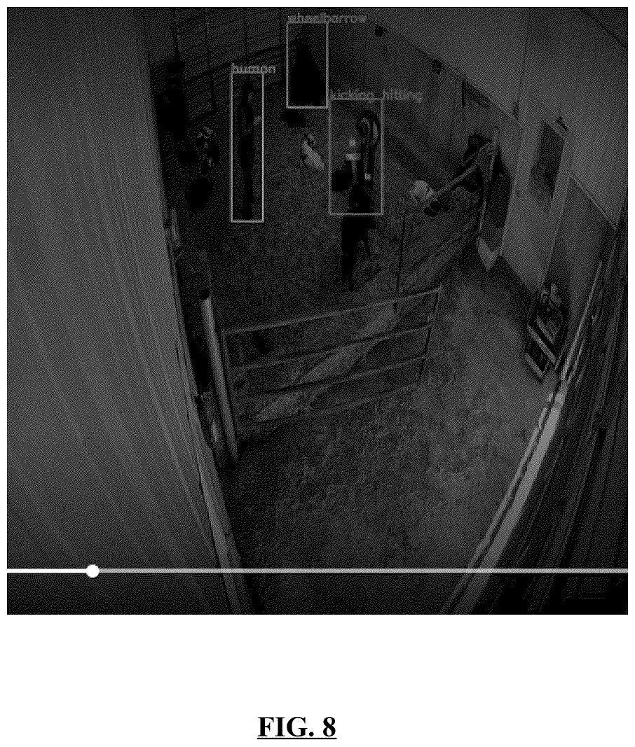

Hitting/kicking or tail twist, these portions of step 130 look at possible abuse of the animal by a human. It may be important for the farm to determine whether humans are hurting the animals, irrespective of the reasons for doing so. FIG. 8 illustrates a screen shot of a video clip showing that method 100 has identified that a human is kicking or hitting a cow. Note that FIG. 8 also identifies a human and a wheelbarrow within the barn, as identified by method 100.

Additionally, step 130 may look for weapons carried by any humans within the camera viewing range. The method 100 may report that there is euthanasia being carried out, such that the operator monitoring a dashboard may confirm whether that is a planned exercise of power.

Calves, which are generally smaller than adult cows, may be more likely to be subject to abuse, because there are less likely repercussions relative to an adult cow. Therefore, the animal welfare block may look for calf dragging or carrying, or abuse of calf ears.

One of the goals of method 100 and step 130 may be to identify whether there is a cow laying down, which may indicate, without limitation, injury or distress. Then, an operator may review the clip and determine whether the cow is simply laying down to rest or sleep, or whether the cow is injured or in some other distress. Following the animal welfare block of step 130, method 100 follows connector B to step 132, which is shown in FIG. 1A.

### Step 132: S3 Bucket.

At step 132, method 100 accesses a special storage area on a cloud server. The cloud server may be an Amazon Web Services (AWS) or another suitable cloud, which will be recognized by those having ordinary skill in the art, and S3 may stand for Simple Storage Service. Alternatively, step 132 may access storage on a local server.

### Step 134: JSON.

At step 134, method 100 accesses and/or writes information to a JSON, which may stand for JavaScript Object Notation and is a lightweight data-interchange format. The JSON is a text file or html file describing the clip, including, without limitation, the camera, site name, links to video, and thumbnails. All of this data may be stored in the S3 bucket or local server.

### Step 136: Third-Party Database.

At step 136, method 100 may access a third (3rd) party database, which may be used to store additional information, including, without limitation, that an animal needs to be sorted in the future for additional attention. The third-party database uses the JSON and, potentially, a clip that has been generated to feed to a UI.

### Step 138: User Interface (UI).

At step 138, method 100 send alerts and/or video clips to a user interface (UI), such as a dashboard monitored by a human. The user may then review the clips to determine whether a problem exists in the clips—including, without limitation, any of the things shown in the animal welfare block—and may determine whether corrective action is needed.

For example, the user of the UI dashboard may determine that the potential or possible problem was misidentified or was a planned action that needed be carried out. Therefore, the user may determine whether the possible problems are actual or real problems. Note that the dashboard need not be on the farm, itself, and it may be remote and/or connected via the cloud or other communications networks.

### Step 140: Reviewed/Unreviewed Clips.

At step 140, method 100 determines and/or notes whether the clips sent to the UI dashboard were reviewed. This may include notifying the user of the UI dashboard that some, or all, clips were not reviewed. Furthermore, method 100 may notify the user that some clips were not reviewed within a specified time, as will be recognized by skilled artisans.

### Step 142: Statistics; End/Loop.

At step 142, method 100 collects statistics and then ends or loops. The collected statistics may include, without limitation: the types of animal welfare issues identified by method 100; the number of false reports, as characterized by the user of the UI dashboard; the number of reviewed and unreviewed clips; the length of the clips and the amount of time before review; or other statistics that will be recognizable to those having ordinary skill in the art. Generally, the statistics apply to animal abuse, but other statistics may also be collected.

For example, and without limitation, method 100 may think that there is harm being done to an animal but, after review, it was determined to be lack of harm, such as administering a shot, which could be corrected later or might prefer to be reported as part of the statistics. Therefore, statistics may be taken on whether harm/un-harm was selected by the dashboard user.

After the statistics are collected and stored, such as in the cloud, method 100 ends or loops, such as back to the start step 110. Additional users may then review the statistics, to determine whether changes are needed.

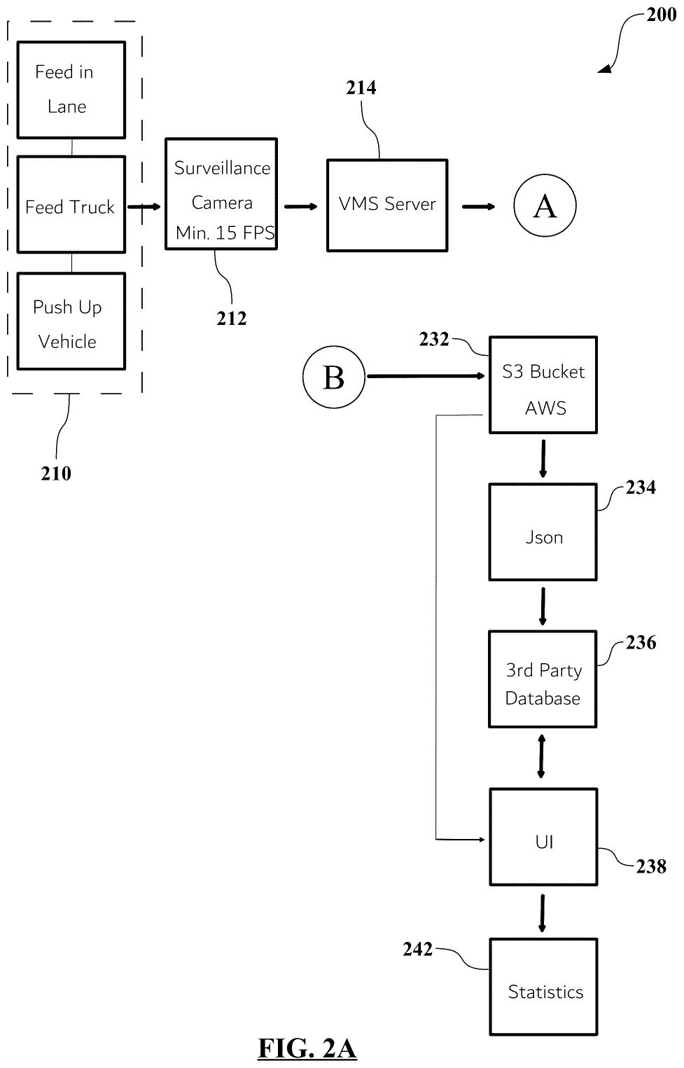

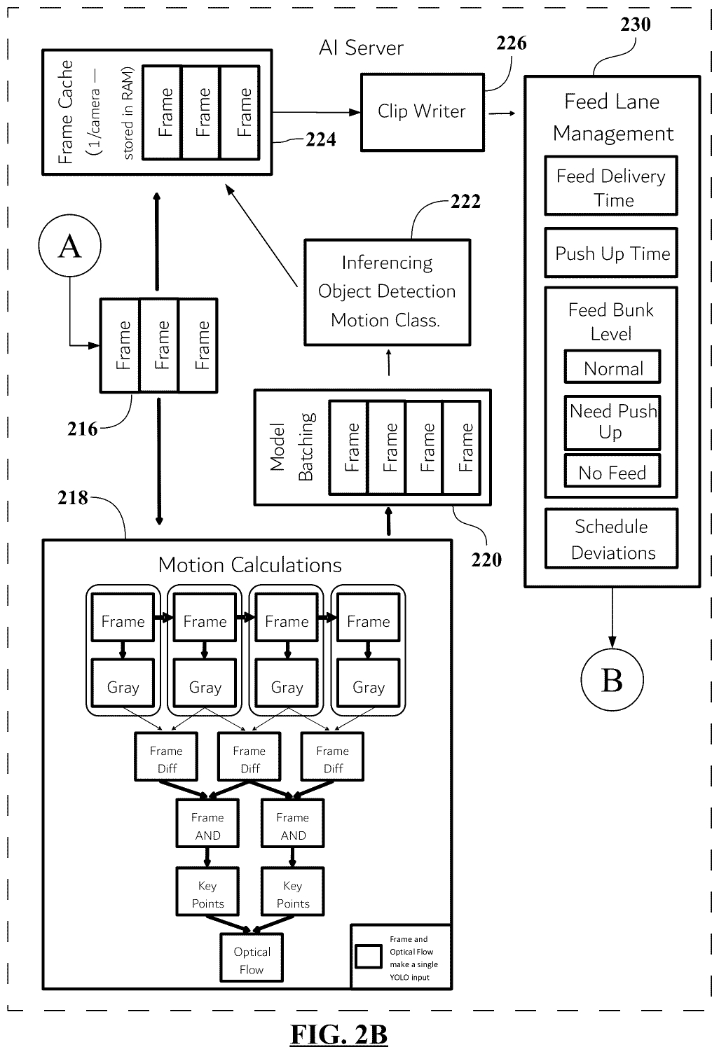

FIGS. 2A and 2B schematically illustrate portions of a flow chart or method 200 focusing on feed lanes. Note that method 200 may move back and forth between FIGS. 2A and 2B.

For the remainder of the flow charts, methods, or processes described herein, the description may only focus on differences between the illustrated method or flow chart and those shown relative to method 100 in FIGS. 1A and 1B. Therefore, some of the steps may be skipped in the description, but are shown in the respective flow chart and, without limitation, may be similar to those described relative to method 100, as would be recognized by those having ordinary skill in the art.

### Step 210: Start; Feed Truck, Pushup, or Feed in Lane.

Method 200 generally starts or begins at a step where the AI method 200 realizes that, at least, one of: a feed truck, a pushup vehicle, or feed are in the lane. Other triggers may also start method 200. Note that all methods described herein may be looping iteratively and/or constantly looking for trigger events to begin any of the processes described herein. Note that methods and systems described herein may recognize other objects, including other equipment used with the feed lanes.

### Step 212: Surveillance Camera.

### Step 214: Video Management Server (VMS).

### Step 216: Frame Processing.

### Step 218: Motion Calculations.

Steps 212 through 218 may be very similar to those discussed relative to method 100 shown in FIGS. 1A and 1B. Note, however, that motion calculations of step 218 may be looking for different elements of motion, such as those related to feeding, as will be recognized by those having ordinary skill in the art.

### Step 220: Model Batching.

### Step 222: Inferencing, Object Detection, and Motion Classification.

### Step 224: Frame Cache.

### Step 226: Clip Writer.

Steps 220 through 226 may be very similar to those discussed relative to method 100 shown in FIGS. 1A and 1B.

### Step 230: Feed Lane Management.

At step 230, method 200 determines whether there are any possible issues with feed lane management. Some of the issues with feed lane management, monitored in block 230, include, without limitation, feed delivery time, pushup time or time between pushups, and deviations from scheduled feeding. The feed delivery schedule will be built in or stored, such that method 200 would notice if the delivery did not happen. Method 200 may also be monitoring the feed bunk levels in block 230, which may include, without limitation, whether the level is normal, whether there is no feed, or whether the feed needs to be pushed up.

### Step 232: S3 Bucket.

### Step 234: JSON.

### Step 236: Third-Party Database.

### Step 238: User Interface (UI).

### Step 242: Statistics; End/Loop.

Steps 232 through 242 may be very similar to those discussed relative to method 100 shown in FIGS. 1A and 1B. Note that the collected/stored statistics may be geared toward, or based on, feed lane issues.

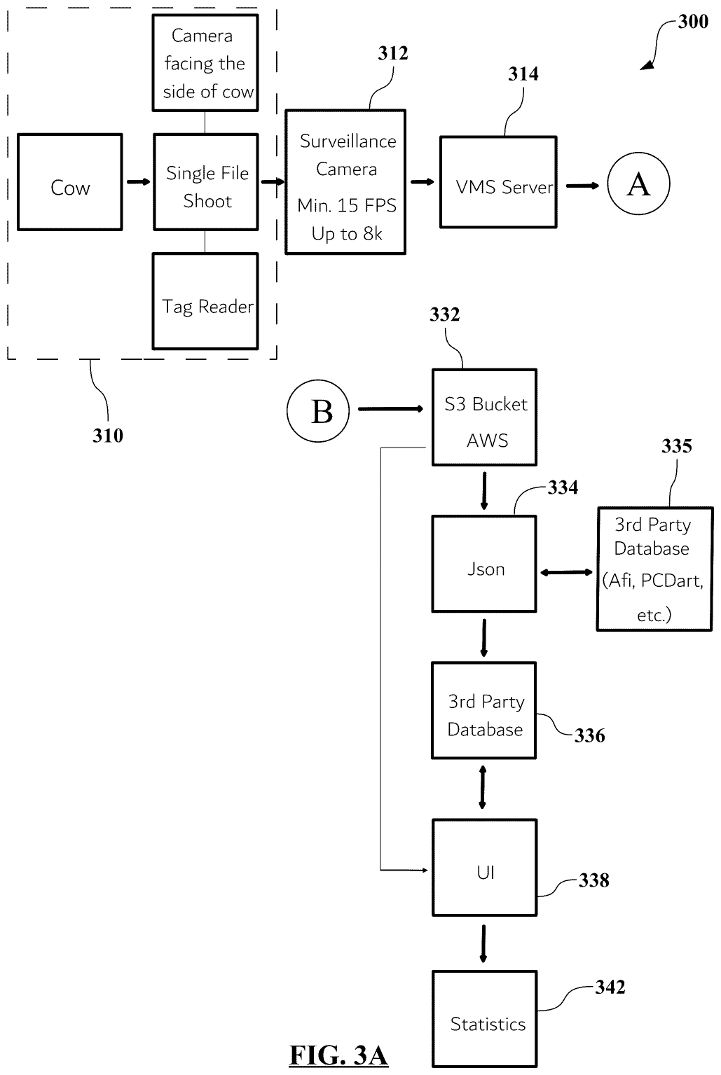

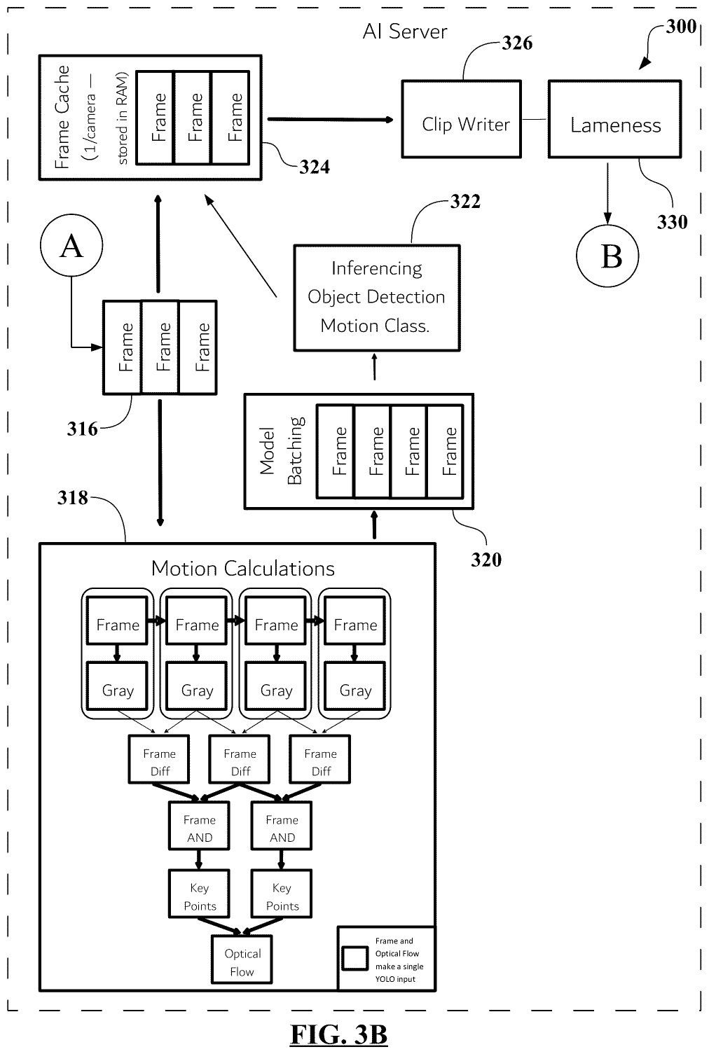

FIGS. 3A and 3B schematically illustrate portions of a flow chart or method 300 focusing on detecting lameness. Note that method 300 may move back and forth between FIGS. 3A and 3B.

### Step 310: Start; Cow for Assessment.

Method 300 generally starts or begins at a step where the AI method 300 realizes that a cow, or other animal, is available for lameness assessment. Other triggers may also start method 300.

As shown in the start block 310, this may include several components or assessment techniques. These include, without limitation, a camera facing the side of the cow, a single file shoot, such that assessment is limited to that cow, and/or a tag reader to help identify the specific cow being assessed.

### Step 312: Surveillance Camera.

### Step 314: Video Management Server (VMS).

### Step 316: Frame Processing.

### Step 318: Motion Calculations.

Steps 312 through 318 may be very similar to those discussed relative to method 100 shown in FIGS. 1A and 1B. Note, however, that motion calculations of step 318 may be looking for different elements of motion, such as those related to identification of lameness in the visualized animal, as will be recognized by those having ordinary skill in the art.

### Step 320: Model Batching.

### Step 322: Inferencing, Object Detection, and Motion Classification.

### Step 324: Frame Cache.

### Step 326: Clip Writer.

Steps 320 through 326 may be very similar to those discussed relative to method 100 shown in FIGS. 1A and 1B.

### Step 330: Lameness Determination.

At step 330, method 300 determines whether there are any possible issues of lameness in the surveyed or visualized animal. Some of the issues recognized as lameness include, without limitation, that the animal has leg or foot pain that affects how they move.

Lameness may be caused by, without limitation: infection, injury, nutrition, genetics, Bovine Respiratory Disease (BRD), or a combination of these factors, sometimes making it a challenge to properly diagnose. Risk factors that can predispose some cattle to lameness include, without limitation: muddy and contaminated pen environments; facility design flaws such as abrasive or slippery flooring; the presence of sharp protrusions or objects; improper animal handling; agitated cattle behavior; other diseases such as Mycoplasma bovis; and/or heavy cattle carrying a lot of weight.

### Step 332: S3 Bucket.

### Step 334: JSON.

Steps 332 and 334 may be very similar to those discussed relative to method 100 shown in FIGS. 1A and 1B.

### Step 335: Third-Party Database.

This third-party database feeds herd management software. This would only receive the JSON feed and it would be embedded into whichever program the farm is already using, such as, without limitation, Afi, MyDC, PCDart, or others recognized by skilled artisans. Note that the type of third-party database used in step 335 may also be used in the other methods to interact with herd management software. The body condition score (BCS) of the lame animal may also be reported the third-party database.

### Step 336: Third-Party Database.

### Step 338: User Interface (UI).

### Step 342: Statistics; End/Loop.

Steps 336 through 342 may be very similar to those discussed relative to method 100 shown in FIGS. 1A and 1B, including the third-party database accessed at step 336. Note that the collected/stored statistics may be geared toward, or based on, lameness issues.

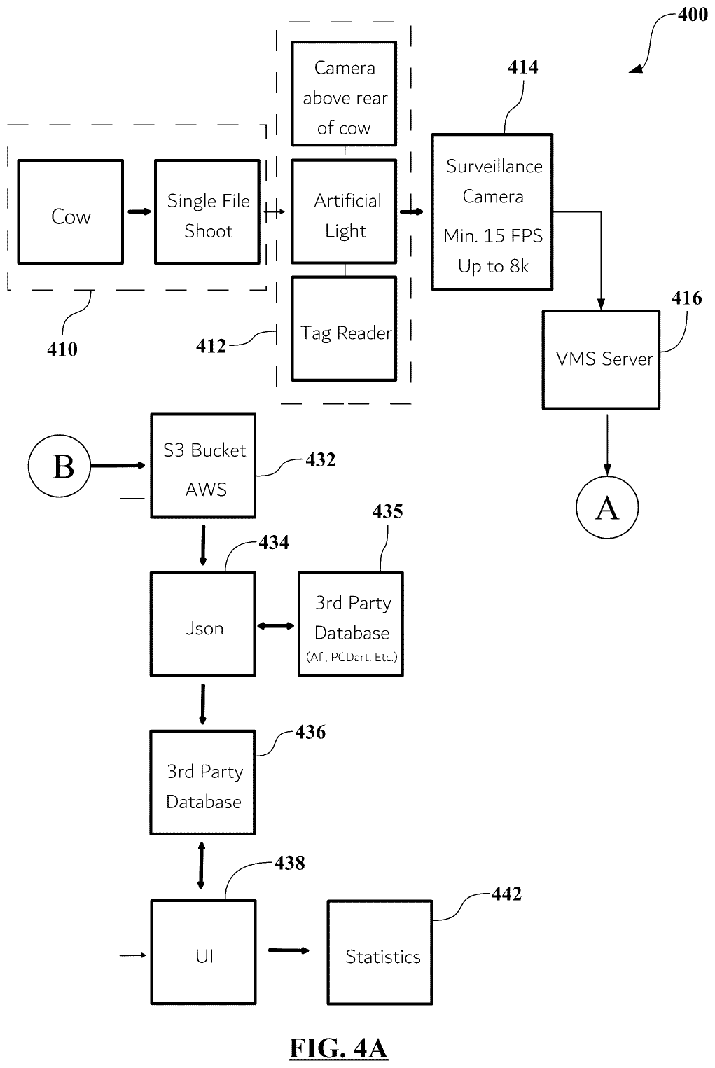

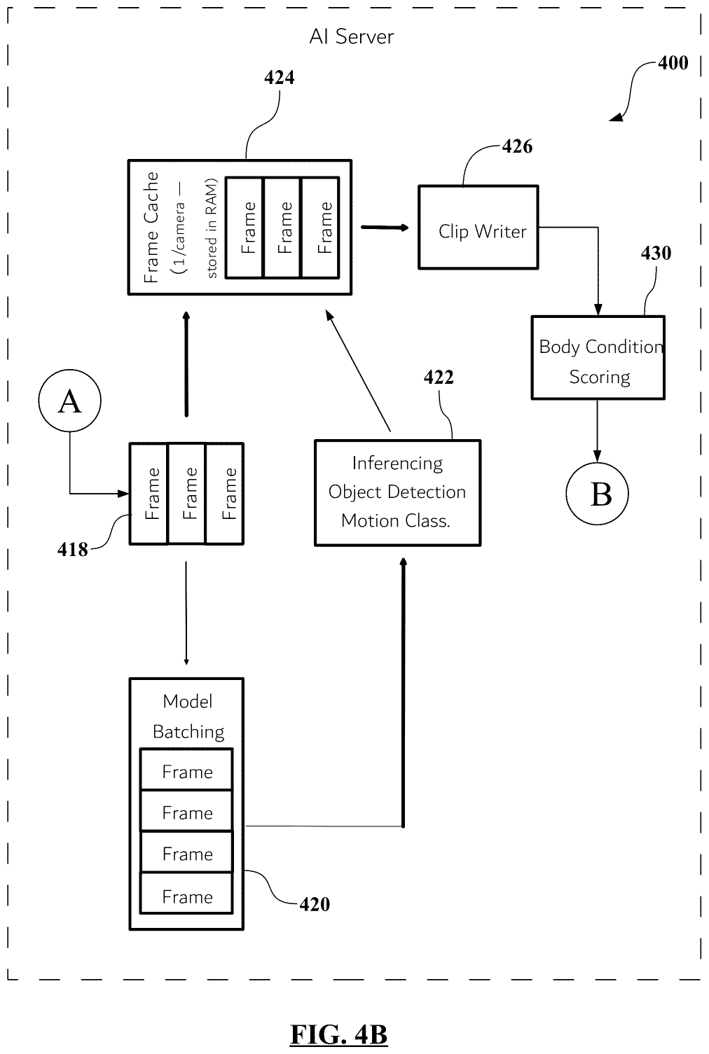

FIGS. 4A and 4B schematically illustrate portions of a flow chart or method 400 focusing on body condition scoring (BCS) of one or more animals. Note that method 400 may move back and forth between FIGS. 4A and 4B.

### Step 410: Start; Cow in Single File Shoot.

Method 400 generally starts or begins at a step where the AI method 400 realizes that a cow, or other animal, is within a single file shoot. Other triggers may also start method 400.

### Step 412: BCS Assessment.

At step 412, method 400 collects information that may be used, in part, for assessment of body condition score of one or more cows or other animals. Included in the BCS assessment, without limitation, may be a camera above the rear of the animal, artificial light applied, and a tag reader to identify the animal.

### Step 414: Surveillance Camera.

### Step 416: Video Management Server (VMS).

### Step 418: Frame Processing.

Steps 414 through 418 may be very similar to those discussed relative to method 100 shown in FIGS. 1A and 1B. Note that there are no motion calculations illustrated in method 400. However, motion calculations may be used for body condition scoring, as will be recognized by those having ordinary skill in the art.

### Step 420: Model Batching.

### Step 422: Inferencing, Object Detection, and Motion Classification.

### Step 424: Frame Cache.

### Step 426: Clip Writer.

Steps 420 through 426 may be very similar to those discussed relative to method 100 shown in FIGS. 1A and 1B.

### Step 430: Body Condition Scoring.

At step 430, method 400 determines the body condition score (BCS) for one or more animals. With cattle, in particular, BCS is an easy-to-use tool that may be used to describe the relative fatness of beef or dairy cattle. A nine-point BCS scale can be used to manage the cow herd. For example, and without limitation, there is a strong correlation between the body condition of a cow and her reproductive performance and productivity. Percentage of open cows, calving interval, and calf vigor at birth are all closely related to the BCS of cows both at calving and during the breeding season.

One of the advantages of using a BCS system is that, with practice, visual indicators, such as those implemented by method 400, can be used and BCS can be measured in the field without gathering or working cattle. For the nine-point BCS scale, it may range from 1, emaciated, to 6, good, to 9, very obese. Note that these values are not limiting, as will be recognized by skilled artisans.

BCS may vary, as a pen, due to environmental factors. Therefore, method 400 may determine the BCS for an entire pen of cattle.

### Step 432: S3 Bucket.

### Step 434: JSON.

### Step 435: Third-Party Database.

This third-party database feeds to one or more herd management software programs. This would only receive the JSON feed and it would be embedded into whichever program the farm is already using, such as, without limitation, Afi, MyDC, PCDart, or others recognized by skilled artisans.

### Step 436: Third-Party Database.

### Step 438: User Interface (UI).

### Step 442: Statistics; End/Loop.

Steps 432 through 442 may be very similar to those discussed relative to method 100 shown in FIGS. 1A and 1B or method 300 shown in FIGS. 3A and 3B. Note that the collected/stored statistics may be geared toward, or based on, body condition scoring or scores.

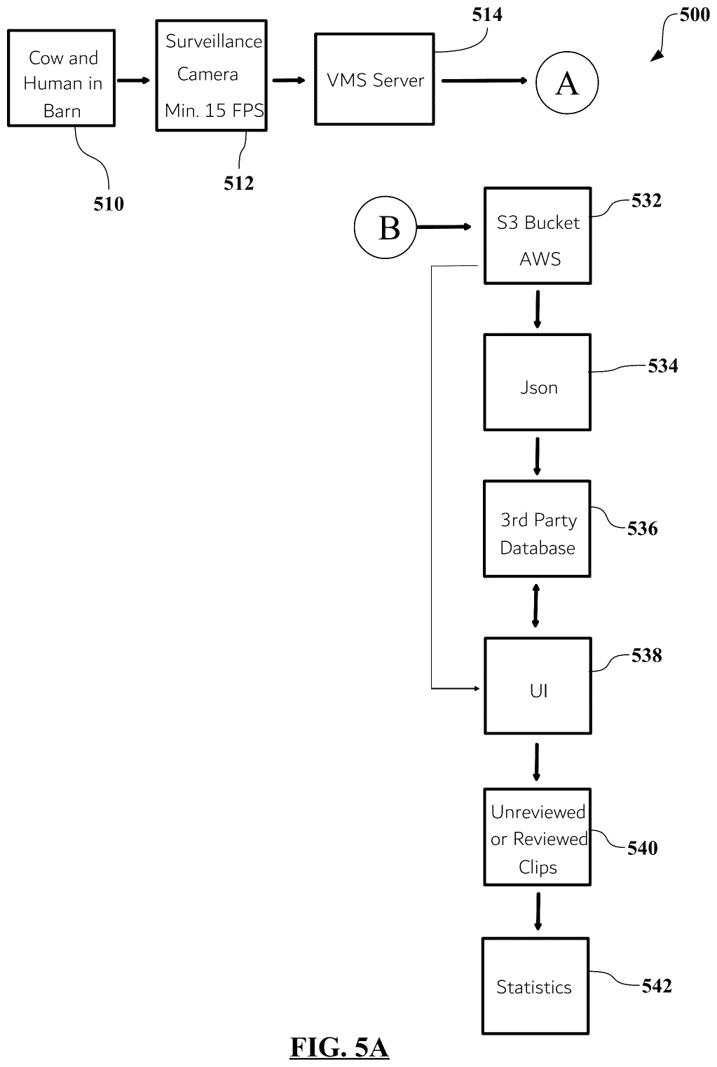

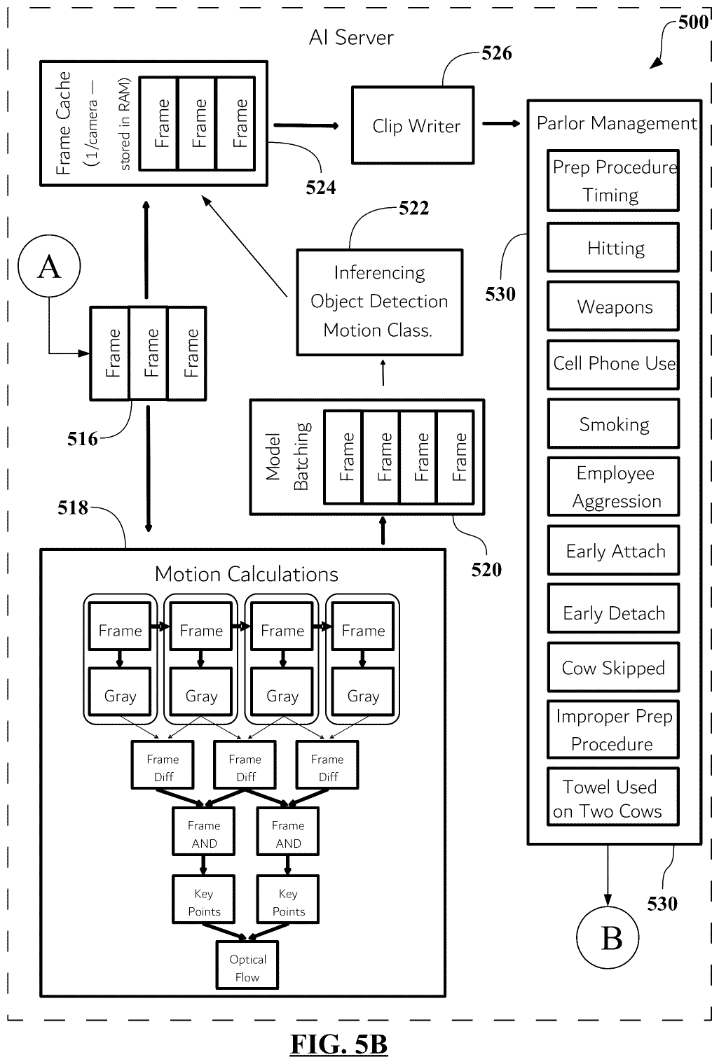

FIGS. 5A and 5B schematically illustrate portions of a flow chart or method 500 focusing on parlor management. Note that method 500 may move back and forth between FIGS. 5A and 5B.

Parlor management generally refers to milking parlors for the animals. The animals move through (likely) an automated milking process and then advance out of the parlor.

### Step 510: Start; Cow and Human in Barn.

Method 500 generally starts or begins at a step where the AI method 500 realizes that a cow and a human are in the barn together. Other triggers may also start method 500. Note that all methods described herein may be looping iteratively and/or constantly looking for trigger events to begin any of the processes described herein.

### Step 512: Surveillance Camera.

### Step 514: Video Management Server (VMS).

### Step 516: Frame Processing.

### Step 518: Motion Calculations.

Steps 512 through 518 may be very similar to those discussed relative to method 100 shown in FIGS. 1A and 1B. Note, however, that motion calculations of step 518 may be looking for different elements of motion, such as those related to parlor management, as will be recognized by those having ordinary skill in the art.

### Step 520: Model Batching.

### Step 522: Inferencing, Object Detection, and Motion Classification.

### Step 524: Frame Cache.

### Step 526: Clip Writer.

Steps 520 through 526 may be very similar to those discussed relative to method 100 shown in FIGS. 1A and 1B.

### Step 530: Parlor Management.

At step 530, method 500 determines whether there are any parlor management issues. Some of the issues looked at regarding parlor management are discussed below. However, the issues discussed are not limiting and those having ordinary skill in the art will recognize additional issues that may be monitored by method 500.

Animal welfare issues within the milking parlor include, without limitation, hitting, weapons, and/or employee aggression. Additionally, method 500 may monitor for distracted employees, including, without limitation, smoking employees and/or those using cell phones or smart devices.

The timing of the prep procedures, for implementation of the automatic milking, may be monitored by, and method 500 may watch for improper prep procedures. A somewhat related issue may involve the same towel being used on two cows.

Method 500 may also watch for cows that are skipped, which may be deleterious to the cow and the milking operations. Stimulation happens and then, within 120 seconds, the milking attachment should hook up. Additionally, method 500 may look for early attachment or early detachment.

### Step 532: S3 Bucket.

### Step 534: JSON.

### Step 536: Third-Party Database.

### Step 538: User Interface (UI).

### Step 540: Reviewed/Unreviewed Clips.

### Step 542: Statistics; End/Loop.

Steps 532 through 542 may be very similar to those discussed relative to method 100 shown in FIGS. 1A and 1B. Note that the collected/stored statistics may be geared toward, or based on, milking parlor management.

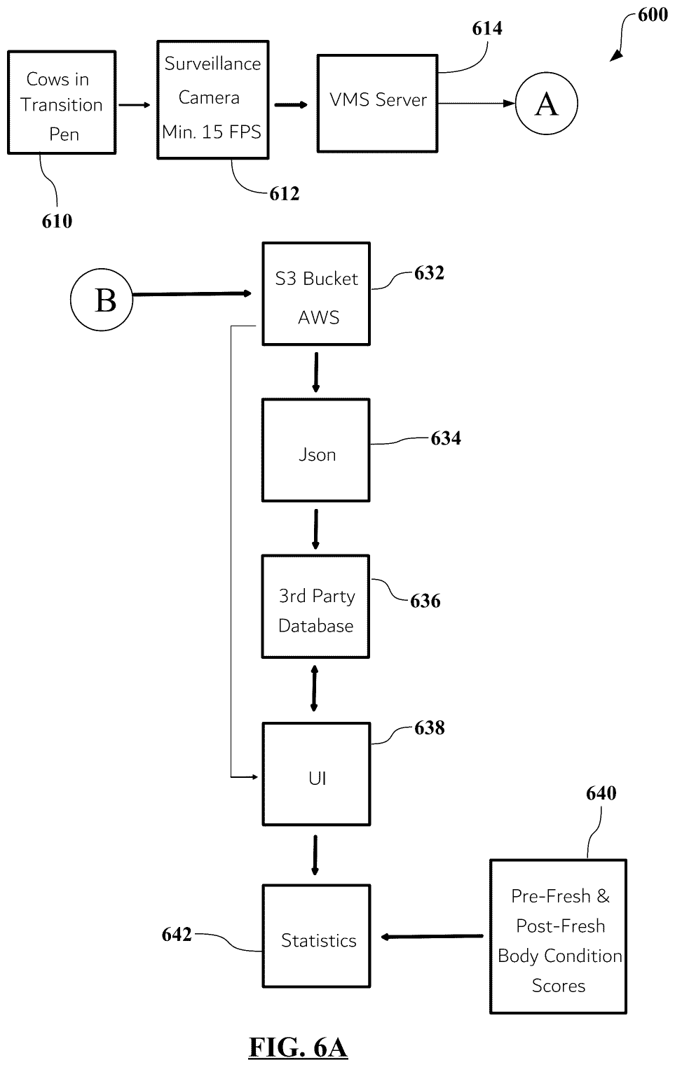

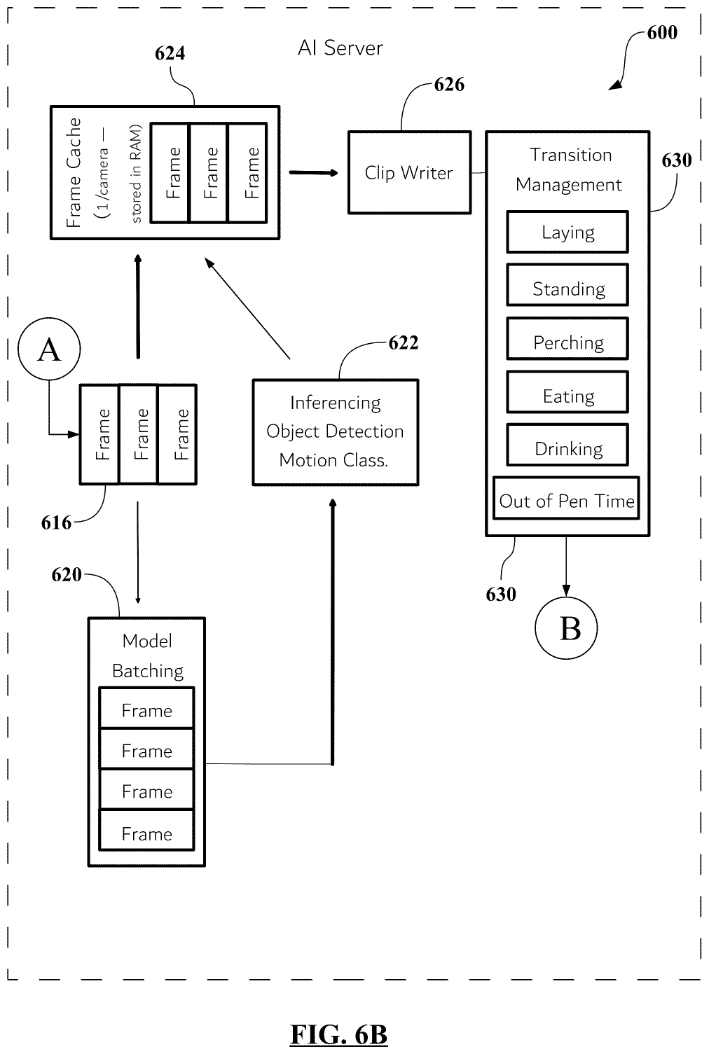

FIGS. 6A and 6B schematically illustrate portions of a flow chart or method 600 focusing on transition management. Note that method 600 may move back and forth between FIGS. 6A and 6B.

The terms “transition” or “transition management,” refer to the process of a cow not producing milk (dry cow), calving, and then producing milk. Note that this also applies to other milk producing animals. Transition management may affect how the cows move between lactation.

The transition period was traditionally the three weeks before calving and the three weeks following calving. However, as we learned more about cow physiology, this period expanded to the 60 days before calving and the 30 days following. These 90 days make up the transition period.

### Step 610: Start; Cows in Transition Pen.

Method 600 generally starts or begins at a step where the AI method 600 notices, or is told, that one or more cows are in the transition pen. Other triggers may also start method 600. Note that all methods described herein may be looping iteratively and/or constantly looking for trigger events to begin any of the processes described herein.

### Step 612: Surveillance Camera.

### Step 614: Video Management Server (VMS).

### Step 616: Frame Processing.

### Step 620: Model Batching.

### Step 622: Inferencing, Object Detection, and Motion Classification.

### Step 624: Frame Cache.

### Step 626: Clip Writer.

Steps 612 through 626 may be very similar to those discussed relative to method 100 shown in FIGS. 1A and 1B. Note that there are no motion calculations illustrated in method 600. However, motion calculations may be used for transition management, as will be recognized by those having ordinary skill in the art.

### Step 630: Transition Management.

At step 630, method 600 determines whether there are any transition management issues. Some of the issues looked at regarding transition management are discussed below. However, the issues discussed are not limiting and those having ordinary skill in the art will recognize additional issues that may be monitored by method 600.

The transition management items monitored in step 630 include, without limitation, whether the cow is standing, laying, or perching. Perching generally refers to a cow standing with two front legs in a stall while the back legs are in a chute.

Method 600 may also monitor whether the cow is eating or drinking. Additionally, step 630 may note when the cow leaves and returns to the transition pen, such that it measures the time out of the pen.

### Step 632: S3 Bucket.

### Step 634: JSON.

### Step 636: Third-Party Database.

### Step 638: User Interface (UI).

Steps 632 through 638 may be very similar to those discussed relative to method 100 shown in FIGS. 1A and 1B.

### Step 640: Pre-Fresh and Post-Fresh BCS.

At step 640, method 600 compares, or notes, the body condition score before entering the transition management system, pre-fresh, and after finishing the transition management system, post-fresh. This may assist in collecting statistics related to the transition management process.

### Step 642: Statistics; End/Loop.

Note that the collected/stored statistics may be geared toward, or based on, transition management.

The detailed description and the drawings or figures are supportive and descriptive of the disclosure. While some of the best modes and other embodiments for carrying out the disclosure have been described in detail, various alternative designs, configurations, and embodiments exist for practicing the appended claims, as will be recognized by those having ordinary skill in the art.

1. A method of using artificial intelligence (AI) to monitor situations, the method comprising:
using one or more cameras to monitor one or more objects;
processing, with AI, images or moving images from the camera;
determining whether a problem is occurring within the images or moving images from the camera; and
reporting possible problems to a receiving point.

2. The method of using artificial intelligence to monitor situations of claim 1, wherein the monitored objects include animals.

3. The method of using artificial intelligence to monitor situations of claim 2, wherein the receiving point is a dashboard monitored by a human, who can review and determine whether the possible problems are actual problems.

4. The method of using artificial intelligence to monitor situations of claim 3, further comprising:
using Optical Flow to capture motion within the images or moving images.

5. The method of using artificial intelligence to monitor situations of claim 4, wherein the possible problems include forms of animal abuse.

6. The method of using artificial intelligence to monitor situations of claim 1, further comprising:
ending or looping, and collecting statistics for animal abuse.

7. The method of using artificial intelligence to monitor situations of claim 1, further comprising:
using Optical Flow to capture motion within the images or moving images.

8. The method of using artificial intelligence to monitor situations of claim 7,
wherein the monitored objects include humans; and
wherein the possible problems reported from the images or moving images from the camera are criminal actions.

9. The method of using artificial intelligence to monitor situations of claim 8, wherein the receiving point is a dashboard monitored by a human, who can review and determine whether the criminal actions are actual criminal actions.

10. A non-transitory computer-readable storage medium on which is recorded instructions, wherein execution of the instructions by a processor causes the processor to:
use one or more cameras to monitor one or more objects;
process, with artificial intelligence (AI), images or moving images from the one or more cameras;
determine whether a problem is occurring within the images or moving images from the one or more cameras; and
report any possible problems to a receiving point.

11. The non-transitory computer-readable storage medium on which is recorded instructions of claim 10, further comprising:
use Optical Flow to capture motion within the images or moving images.

12. The non-transitory computer-readable storage medium on which is recorded instructions of claim 11, further comprising:
end or loop, and collect statistics for animal abuse.

13. The non-transitory computer-readable storage medium on which is recorded instructions of claim 12,
wherein the monitored objects include humans; and
wherein the possible problems reported from the images or moving images from the one or more cameras are criminal actions.

14. The non-transitory computer-readable storage medium on which is recorded instructions of claim 13, wherein the receiving point is a dashboard monitored by a human, who can review and determine whether the possible problems are actual problems.

15. The non-transitory computer-readable storage medium on which is recorded instructions of claim 12, wherein the possible problems are forms of animal abuse.
